(19) United States
(12) Patent Application Publication
(10) Pub. No.: US 2009/0164502 A1
(43) Pub. Date: Jun. 25, 2009

(54) SYSTEMS AND METHODS OF UNIVERSAL RESOURCE LOCATOR NORMALIZATION

(76) Inventors: Anirban Dasgupta, Berkeley, CA (US); Amit Sasturkar, Santa Clara, CA (US); Shanmugasundaram Ravikumar, Berkeley, CA (US); Rajat Ahuja, San Jose, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/963,925

(22) Filed: Dec. 24, 2007

(51) Int. Cl. G06F 17/30

(52) U.S. Cl. 707/102; 707/E17.046

(57) ABSTRACT

Disclosed herein are method, systems and architectures for normalizing identifiers corresponding to resources using normalization rules that can be generalized for use with different resources. By way of a non-limiting example, an identifier can be a uniform resource locator (URL), and a normalization rule can be used to normalize URLs that correspond to different resources, e.g., content. A normalization rule can be generated by generalizing two or more normalization rules corresponding to different resources, such that a content determinative component is generalized. A normalization rule can be defined to include a context portion used to determine the rule's applicability to an identifier, and a transformation portion that identifies the transformations to be applied to an applicable identifier to yield a normalized form of the URL. A generalization of two or more normalization rules can include a normalization of one or both of the context and transformation portions.

### FIELD OF THE INVENTION

The present disclosure relates to identifying duplicate search results, and more particularly to identifying duplicate documents using universal resource locator information associated with each document.

### BACKGROUND

Documents are stored in electronic form in storage repositories, which can be physically located at many different geographic locations. With the Internet, and/or other computer networks, computer users are able to access these documents via one or more network servers. Tools, such as search engines, are available to the user to search for and retrieve these documents. A search engine typically uses a utility referred to as a crawler, to locate stored documents. Results of one or more “crawls” can then be used to generate an index of documents, which can be searched to identify documents that satisfy a user's search criteria.

The results of a crawl can return more than one copy of the same document, each copy of the document being stored electronically in a file which has a unique label, or name. The unique name is intended to uniquely identify the file. It does not, however, indicate whether or not the contents of the file are unique. In a case of the web, a resource, which includes a file containing a document, has a universal resource locator, or URL. Each URL conforms to a known format, or syntax, and is intended to uniquely identify the file. As with a file name, although it uniquely identifies a file, a URL does not guarantee that the contents of the file to which it is associated are unique.

As discussed, each file is given a unique name, which in the case of the web is referred to as its URL. A typical crawler returns each file that it finds without regard to the contents of the file. The crawler may be programmed to identify two or more files that have URLs that are exactly alike. Since two or more files with unique URLs can have the same contents, however, the crawler can identify such files during a crawl unaware that the files that it finds have the same contents. This results in the crawler returning each of the files containing the same content that it encounters during the crawl. An index that is created from the results of the crawl would then include each duplicate, a search that is conducted from the index could contain duplicate results. In addition and in a case that copies of the files/documents identified during the crawl are archived, duplicates of the same documents would be saved. A drain on resources results, with significant impact on storage, bandwidth, processing, etc., to index and archive the results of the crawl, for example.

In addition, the impact can be felt with each search, from the perspective of both the serving a search and the entity, e.g., the user, requesting the search. A search typically involves a user who enters search criteria, which typically includes one or more search terms, and a server, or other computer system, which receives the search criteria and generates a set of results, which are returned to the user for review. More particularly and in response to the request, the server uses the above-discussed index, which includes duplicates, to identify the set of results to be returned to the user. Since the index includes duplicates, the search results that are returned to the user can identify duplicates. In effect, the burden of identifying duplicate documents is placed on the user, who uses the server's resources as well as network resources to retrieve the documents for review. Computing resources are needlessly used so that the user can identify the duplicates. In addition, the user can become frustrated, since the user must expend the time and effort to review the duplicates.

### SUMMARY

The present disclosure seeks to address failings in the art and to provide resource identifier normalization that can be generalized by generalizing resource determinative portions of the resource identifier.

Disclosed herein are method, systems and architectures for normalizing identifiers corresponding to resources using normalization rules that can be generalized for use with different resources. By way of a non-limiting example, an identifier can be a uniform resource locator (URL), and a normalization rule can be used to normalize URLs that correspond to different resources, e.g., content. A normalization rule can be generated by generalizing two or more normalization rules corresponding to different resources, such that a content determinative component is generalized. A normalization rule can be defined to include a context portion used to determine the rule's applicability to an identifier, and a transformation portion that identifies the transformations to be applied to an applicable identifier to yield a normalized form of the URL. A generalization of two or more normalization rules can include a normalization of one or both of the context and transformation portions.

In accordance with one or more embodiments, a method is provided that groups a plurality of uniform resource locators (URLs) that correspond to a resource, each group having URLs whose resource is determined to correspond and each resource determined to be different between groups; examines each group of URLs to determine at least one normalization rule for the group based on the URLs in the group, each URL in the group comprising at least one component determinative of the resource represented by the URLs in that group; and examines at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

In accordance with one or more embodiments, a computer-readable medium is provided that stores computer-executable program code to group a plurality of uniform resource locators (URLs) that correspond to a resource, each group having URLs whose resource is determined to correspond and each resource determined to be different between groups; examine each group of URLs to determine at least one normalization rule for the group based on the URLs in the group, each URL in the group comprising at least one component determinative of the resource represented by the URLs in that group; and examine at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

In accordance with one or more embodiments, a system is provide that comprises one or more processors configured to group a plurality of uniform resource locators (URLs) that correspond to a resource, each group having URLs whose resource is determined to correspond and each resource determined to be different between groups; examine each group of URLs to determine at least one normalization rule for the group based on the URLs in the group, each URL in the group comprising at least one component determinative of the resource represented by the URLs in that group; and examine at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

### DRAWINGS

The above-mentioned features and objects of the present disclosure will become more apparent with reference to the following description taken in conjunction with the accompanying drawings wherein like reference numerals denote like elements and in which:

FIG. 1, which comprises FIGS. 1A to 1E, provides examples of URLs and URL clusters used in accordance with one or more embodiments of the present disclosure.

FIG. 2 provides an example of a process flow used in accordance with one or more embodiments of the present disclosure.

FIG. 3 provides an example of a rule generation process flow for use in accordance with one or more embodiments of the present disclosure.

FIG. 4 provides a generate rule process flow for use in accordance with one or more embodiments of the present disclosure.

FIG. 5, which comprises FIGS. 5A and 5B, provides a rule generalization process flow for use in accordance with one or more embodiments of the present disclosure.

FIG. 6 provides a filter process flow for use in accordance with one or more embodiments of the present disclosure.

FIG. 7 illustrates some components that can be used in connection with one or more embodiments of the present disclosure.

### DETAILED DESCRIPTION

In general, the present disclosure includes a URL normalization system, method and architecture.

Certain embodiments of the present disclosure will now be discussed with reference to the aforementioned figures, wherein like reference numerals refer to like components.

Duplicate URLs, or other resource identifiers occur on the Internet, or other network or computing environment, for a number of reasons. By way of a non-limiting example, resources can be duplicated as a result of the fact that multiple sites host the same resources, e.g., mirroring document, content, etc. resources for load balancing and fault tolerance. However, the same resource may have a different URL, which can be the result of dropping a portion of the URL, simple syntactic modifications such as removing the trailing slash, interchanging upper and lower cases etc. Dynamic scripts frequently encode session-specific identifying information in the URL, e.g., to track the user and the session, which identifying information usually has no significance on the content of the page. i.e., such information is typically content neutral. The presence of such content-neutral parts in a URL is one of the reasons for the proliferation of duplicate URLs, or identifiers, being used for the same content. In addition, the order of dynamic parameters, which is mostly inconsequential with respect to the content of a URL, can result in resource proliferation. Such structured transformations on the URL string typically occur from processing performed by a server. By understanding such transformations, it is possible to detect whether two URLs correspond to the same or similar content even without explicitly examining the content. The identification of duplicate URLs can facilitate resource usage and processing, and minimize proliferation of the resources and corresponding URLs.

In accordance with one or more embodiments, resource identifiers, e.g., URLs, are “de-duped”. By virtue of such embodiments, functions such as those performed by search engines, including crawling, indexing, ranking, and presentation, can be optimized. In accordance with one or more such embodiments, de-duping can be performed without a need to fetch and/or examine the contents of the resource associated with a URL.

Embodiments of the present disclosure use a collection of URLs, a learning set of URLs, to generate a set of rules that can be used to normalize URLs and determine whether two or more URLs are duplicates of one another. In accordance with one or more such embodiments, URL strings are examined, and a set of rewrite, or normalization, rules are generated. The normalization rules can be used to convert a URL to a normalized form, which normalized form can be compared with another URL's normalized form to determine whether the URLs are duplicate URLs.

In accordance with at least one embodiment, rules are learned that can be deployed in conjunction with a web crawler to de-dup URLs at the crawling stage, e.g., prior to retrieving the resource associated with the URL, to avoid crawling duplicate URLs. Considering that duplicate URLs constitute a large portion of the web, learning URL rewrite rules and deploying them in the crawler can tremendously improve the efficiency of not only the crawler but also subsequent steps in the processing pipeline. Rewrite rules specific to a particular web server, and more specifically, to the software used by the web servers are likely to be stable and have a long life than the actual URLs themselves.

Embodiments of the present disclosure identify content neutral portions of a URL, e.g., URL portions that are irrelevant to the content associated with the URL, e.g., can be replaced by any string without changing the content. A rule that uses a simple substring substitution is insufficient to address content neutral portions. A reason for this is that a simple substring substitution, can result in rules being generated for each pair of distinct values. Simple substring substitution cannot generate a rule that can be used regardless of the distinct content neutral values encountered. Embodiments of the present disclosure use context, or condition, information and information to identify portions of the URL as being irrelevant, e.g., content neutral or irrelevant path information. One or more such embodiments generalize two or more rules into a single rule.

Embodiments of the present disclosure formalize URL rewrite rules that form an efficiently learnable class and are expressive enough to capture the URL transformations. Embodiments of the present disclosure provide a system, method and architecture to learn the URL rewrite rules from a set of URLs having associated similarity information. In experimentation conducted using one or more embodiments of the present disclosure, it has been shown that the URL rewrite rules learned in accordance with embodiments of the present disclosure substantially reduces the number of duplicate URLs, e.g., by 60%.

Embodiments of the present disclosure provide a structure to learn simple string substitution, and generalize URL rewrite rules, including session-id parameters, irrelevant path components, and more complicated URL token transpositions.

Elimination of duplicate database records, which compare the content of one database record with the content of another database record to identify a duplicate record is unlike embodiments of the present disclosure. In contrast to finding duplicate records by examining the content of the records themselves, embodiments of the present disclosure de-dupe URLs using a set of rewrite rules developed from a “learning set” of URLs, without a need to examine the resource, e.g., content, associated with a URL. Embodiments of the present disclosure achieve de-duping using a set of rules developed from a learning set of URLs for use in normalizing URLs encountered after the rules are developed. Embodiments of the present disclosure use an inductive learning approach that generalizes rewrite rules. For example and in accordance with one or more such embodiments, a regular expression can be identified using a finite set of examples.

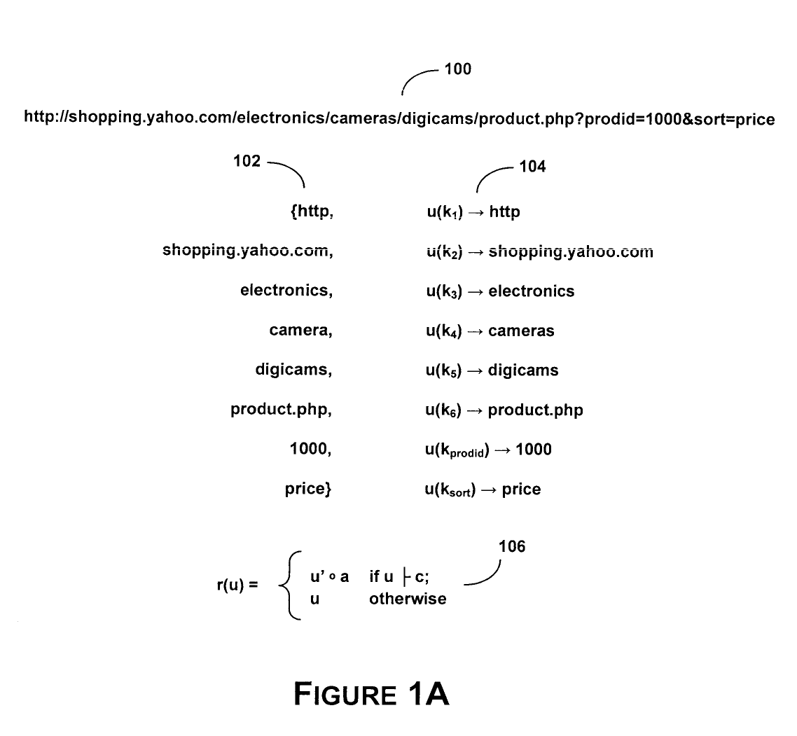

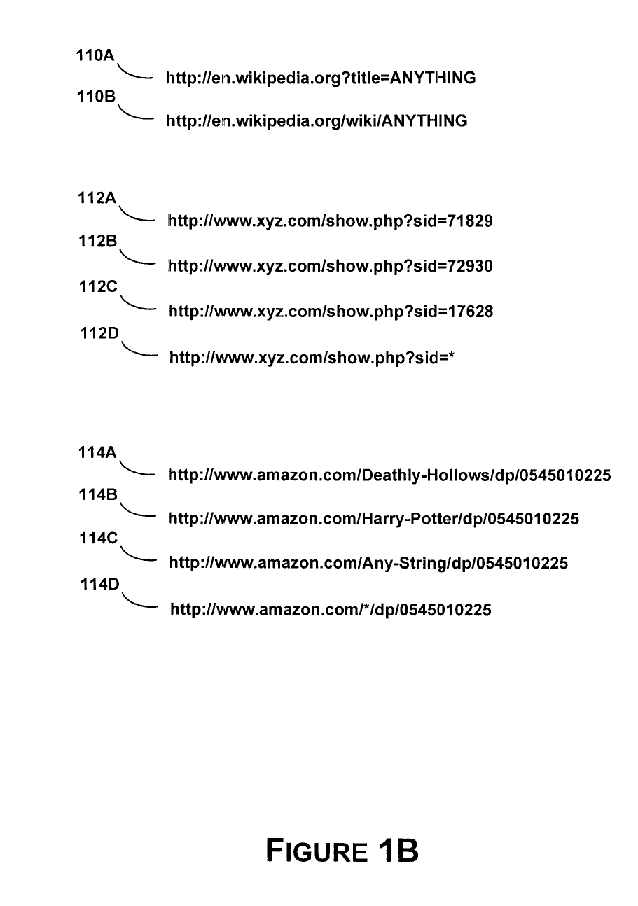

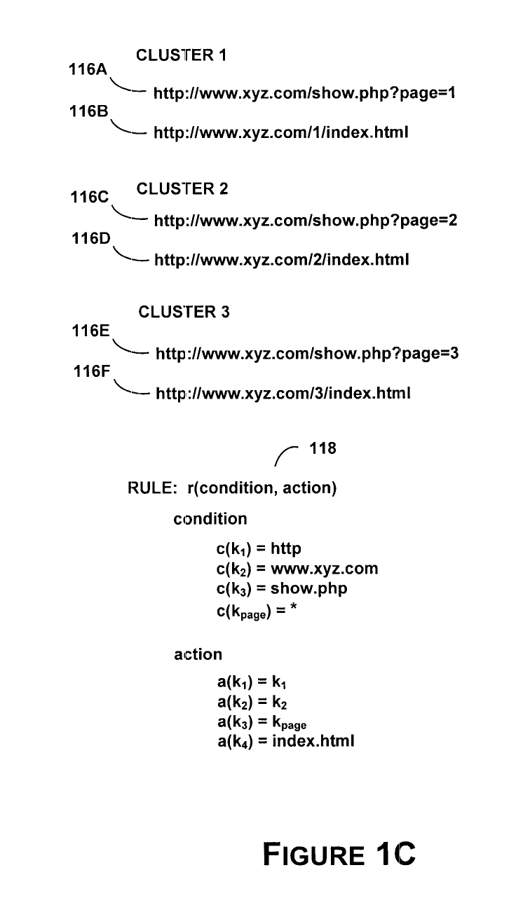

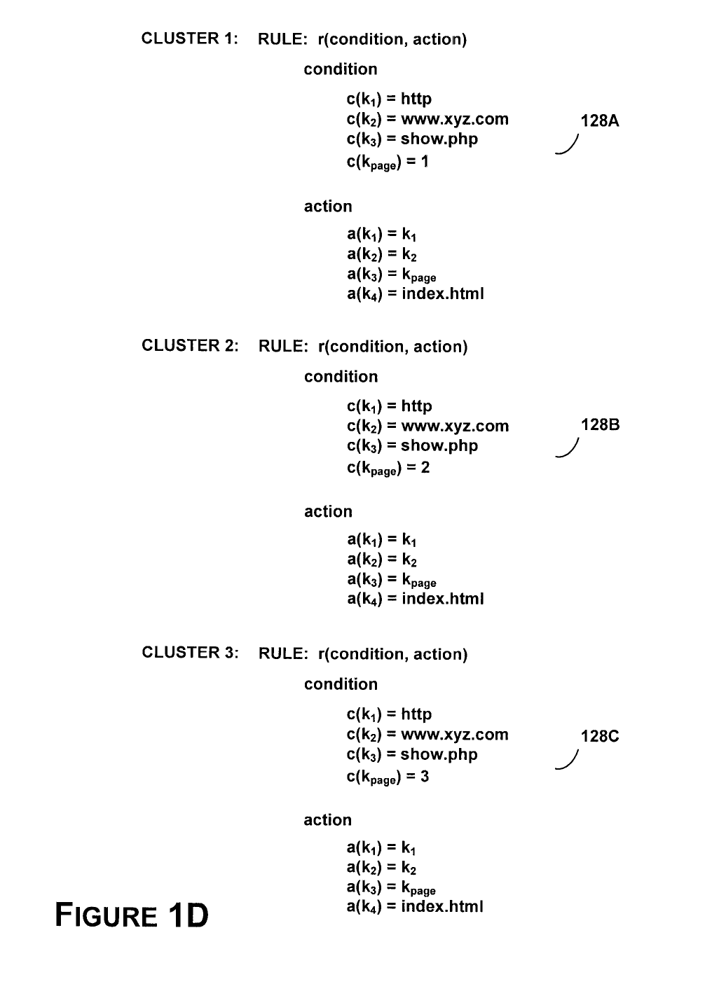

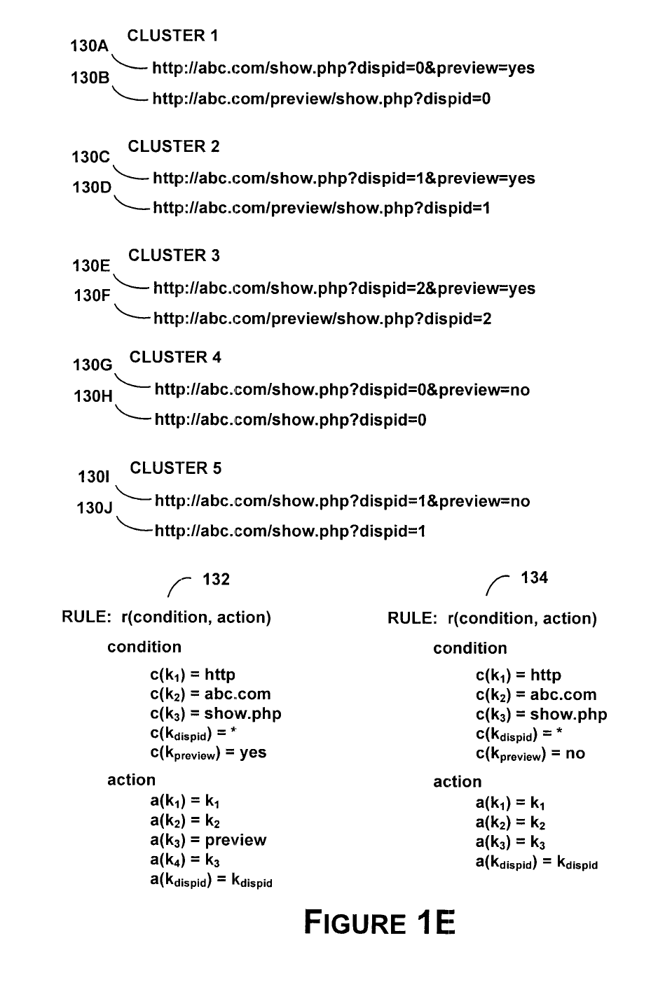

Given a resource identifier, such as a URL, embodiments of the present disclosure represent the URL as a function that maps each key in a set of keys to a value in a set of values. The set of keys and values for the URL can be identified by parsing the URL to identify its parts, and splitting the URL into its parts, which parts can comprise static parts, e.g., protocol, hostname, and static path components, and dynamic parts, e.g., parameters and their values. The parsing to identify parts of the URL can use a known syntax for the URL, e.g., separator tokens such as separator/for the static parts and ?, & and ; for the dynamic parts. Key-value pairs are identified, which can have a format of key=value. The keys that correspond to the static portion can be represented as {k₁, . . . , kₙ}, where n represents the number of components in the static part. For the dynamic part, each parameter in the URL can be defined as a key. FIG. 1A provides an example of a URL that has static and dynamic parts identified in accordance with one or more embodiments of the present disclosure. URL 100 comprises parts 102, which include static parts, e.g., protocol http, hostname shopping.yahoo.com, and path components electronics, camera, digicams, and dynamic parts, e.g., prodid=1000, and sort=price.

Let K denote a universe of keys associated with all of the URLs, and V denote the set of all tokens from all possible URLs, augmented with the token “⊥” that denotes an empty value. In accordance with at least one embodiment, in describing a URL u, it is assumed that u maps the keys in K to the default empty value “⊥” unless otherwise specified. The set of all possible URLs will be denoted by U. A URL u can comprise a map u: K →V from the set of keys, K, to the set of values, V. In the example shown in FIG. 1A, the url 100 comprises keys {k₁, . . . , k₆, k_{prodid}, kₛₒᵣₜ} and values corresponding to the keys, http, shopping.yahoo.com, electronics, digicams, product.php, 1000, and price, which are shown in key-value pairs 104. The remaining elements of K can mapped for URL 100 to the empty value, “⊥”.

A rule can be characterized in terms of two properties: a context, or condition, which can be used to identify the set of URLs to which the rule applies, and a transformation, or action, which identifies how the rule is applied to change the URL. A set, W, can comprise a set of values, V, which comprises the empty value and is extended with any regular expression characters. By way of a non-limiting example, such a regular expression uses a wild card character, and can be written as W=V ∪{*}, where ∪ represents a union and * represents a wildcard character that can match any non-empty value in V. It should be apparent that any regular expression and/or any wildcard character can be used in accordance with embodiments of the present disclosure. A context can be defined as a function c: K →W, that maps each key in K to a value in W. By way of non-limiting examples, a context, c, that includes a transfer protocol and a hostname can include c(k₁)=http and c(k₂)=shopping.yahoo.com. A URL u that matches the context c can be written as u ├c, wherein ├ indicates a match operator, if for every key k, either c(k)=*, or u(k)=c(k). A set of possible contexts can be represented as C.

An extended key set, K′, can be expressed as the set K′=K ∪W. In other words, the extended key set K′ can comprise the keys in key set K and the values in the extended value set W. A transformation, a, which can be a member of a set of transformations, A, can be expressed as a mapping from K to K′, or K →K′. By way of a non-limiting example, the function, a, can describe a target URL in terms of the key-value pairs of the source URL, in addition to having new key-value pairs. In order to define an action of a rewrite rule on a URL, the definition of a URL can be extended. By way of a non-limiting example, a family of extended URL functions can be expressed as U′: K′→W. For every URL, u, that is a member of the set of URLs, i.e., u C- U, the extended version of u, u′, can be defined to be equal to u(x) if x C- K, and otherwise is equal to x.

A set of canonical URLs, U_{c}, can be defined to be the set of mappings from K to W, for the set of mappings K →W. A rewrite rule, r, can be defined as a mapping from the set of URLs U to the set of canonical URLs U_{c}. Each rule r can be expressed as a tuple having at least two parts: a context c and a transformation a. Given a rewrite rule tuple (c, a), a rewrite rule r(c,a) that maps a URL in the set U to a canonical URL in the set of canonical URLs U_{c} can be defined using expression 106 of FIG. 1A. A rule r′=(c′, a′) is considered to be less general than r=(c, a), written as r′≦r, if for all keys, or tokens, k, c(k)=“⊥”=c′(k), or c′(k)=c(k) or c(k)=*. A rule, r′, can be said to be a child of r if there is no rule r″(≠r, r′) such that r′≦r″≦r.

Embodiments of the present disclosure can be used to accommodate string substitutions, which string substitutions can be generalized. FIG. 1B provides an example of two URLs that involve a string substitution addressed in accordance with one or more embodiments of the present invention. In the examples shown, URL 110A differs from URL 110B at the third key in the URLs, i.e., ?title in URL 110A and wiki in URL 110B. Assuming that URL 110B is to be the canonical form of the URLs, a rewrite rule is to transform URL 110A to URLB. Such a rule can be include a transformation that performs a substitution of the substring ?title with the substring wiki, which can be expressed as ?title →wiki.

A context c for the rule comprises c(k₁)=http, c(k₂)=en.wikipedia.org, c(kₜᵢₜₗₑ)=*. For all other keys k′ of key set K, c(k′)=“⊥”. A transformation, or action, a for the rule can be defined as actions a(k1)=k1, and a(k2)=k2, such that the first two path components of the target URL 110B are the same as the first two path components of the source URL 110A. The transformation a further includes a(k3)=wiki, a(k4)=kₜᵢₜₗₑ such that the value of the third path component in URL 110A is transformed to be the value wiki, and the value of fourth component in URL 110A is transformed to be the value of the value associated with title parameter, or variable, in the source URL 110A. The transformation function can be defined as u′∘a(k1)=http, u′∘a(k2)=en.wikipedia.org, u′∘a(k3)=wiki, and u′∘a(kₜᵢₜₗₑ) is the value that is associated with the variable title in the source URL 110A.

Embodiments of the present disclosure can be used to accommodate session identifiers found in URLs, or more generally, any content-neutral parameter. Suppose a parameter sid in the URLs 112 is content neutral. In accordance with one or more embodiments, the canonical URL for all of the URLs 112A to 112C can be represented as URL 112D. The rule corresponding to the canonical form defines the context c as c(k₁)=http, c(k₂)=www.xyz.com, c(k₃)=show.php, and c(k_{sid})=*, and the transformation a as a(kᵢ)=kᵢ for i equal to any of {1, 2, 3} and a(k_{sid})=*. In this example, both the context and the transformation are expressed using a wildcard.

Content-neutral parameters, including without limitation session IDs, parameters and irrelevant path components can be referred to jointly as irrelevant path (IRP) rules. Embodiments of the present disclosure can be used to accommodate irrelevant path components found in a URL, such as a session-id parameter found in a static part of a URL. URLs 114 provide examples of URLs 114, which differ at k₃ of each URL 114A to 114C. The URL 114D provides an example of a canonical form of the URL corresponding to URLs 114A to 114C. A rule corresponding to the canonical form can be expressed as context c comprising c(k₁)=http, c(k₂)=www.amazon.com, c(k₃)=*, c(k₄)=dp, and c(k₅)=*, and a transformation a comprising a(kᵢ)=kᵢ, for i equal to {1, 2, 4, 5} and a(k₃)=*.

Embodiments of the present disclosure can involve more complicated rewrites that capture token transpositions, converting the parameter values to static components, which can be captured by suitably defining a transformation function. For instance, consider the clusters of URLs shown in FIG. 1C, which URLs include multiple values for a page parameter, the URLs in each cluster pointing to a same content. The value of the page parameter is being used as a path component. The rule used to perform the transformation can be written using a: (i) context c defined as c(k₁)=http, c(k₂)=www.xyz.com, c(k₃)=show.php, and c(k_{page})=*, and (ii) transformation a defined as a(kᵢ)=kᵢ for i equal to {1, 2}, a(k₃)=k_{page} and a(k₄)=index.html.

Complicated rewrites such as regular-expression substitution rules can be referred to as REGX rules, and can include string substitutions. Such rewrites cannot be captured by reducing the URLs in the cluster to their common form, i.e., taking an intersection of the URLs in a cluster, and then trying to generalize across clusters using the common forms generated for the clusters. If the rule in a cluster is a regular expression transformation, e.g., a transformation other than an irrelevant path component, then generating only one canonical URL in a cluster results in incomplete or unsatisfactory rule discovery. To illustrate, the URLs 116 in cluster 1, 2, and 3 shown in FIG. 1C reduce to the same common form, i.e., the string http://www.xyz.com/, which is arrived at for each cluster by taking an intersection of the URLs in the cluster. There is no ability to use the common form identified for each cluster to generate a single canonical URL applicable for all of the clusters.

Using one or more embodiments, however, a rule 118 can be generated that substitutes components in the URLs, e.g., converting a page parameter found in URLs 116 to a path component. Rule 118 is a generalized rule, which provides for substitutions, and which can be used across all of the clusters. The rule 118 comprises a context c(k₁)=http, c(k₂)=www.xyz.com, c(k₃)=show.php, c(k_{page})=*, and a transformation that comprises a(k₁)=k₁, a(k₂)=k₂, a(k₃)=page, a(k₄)=index.html, which applies to the URLs in each of the clusters.

FIG. 1D provides examples of the rules that can be generated from the URLs in each of the clusters shown in FIG. 1C prior to generalization. Rule 128A is generated from an examination of the URLs in cluster 1, rule 128B is generated from an examination of the URLs in cluster 2, and rule 128C is generated from an examination of the URLs in cluster 3. Rules 128 can be examined to determine that key k₃ is to be replaced by the value of the key k_{page}, and that the key k_{page} value is different for each cluster. The k_{page}, component is not content neutral, but is rather determinative of the content, and the content determinative component varies from one cluster to the next in a way that can be generalized. To generalize the rules across the clusters, embodiments of the present disclosure examine the rules 128 to generate rule 118, which comprises a condition portion generalized on k_{page}, and the transformation portion identifies the substitution of the key k_{page} component for key k₃ in a case that a URL satisfies the condition portion of the rule. The resulting rule generalizes a string substitution such that any URL that satisfies the condition portion of rule 118 can be transformed to a normalized URL using the action portion of rule 118. The action portion of rule 118 performs a string substitution in generating the normalized URL, e.g., uses whatever value of the page parameter found in the original URL for the third component and replaces the k_{page} component in the original URL with the index.html string.

FIG. 1E provides another example of generating a rule by examining the URLs 130 in the clusters 1 to 5 in accordance with one or more embodiments. As with the example of FIG. 1C, generating one common URL per cluster and then examining the common URLs generated for the clusters unnecessarily limits the rule(s) that can be generated. By creating a common URL for each cluster based on an intersection of the URLs in each cluster results in a URL http://abc.com/show.php?dispid=* for each cluster. An attempt to generalize based on the common URL results in the preview component being generalized to be preview=*, which would yield erroneous results when such a rule is applied.

Generating a canonical per cluster based on the intersection of the URLs in the cluster increases the possibility that components missing from the resulting URL are assumed to be content neutral components. As can be seen from the example in FIG. 1E, when each cluster is examined independently to generate the URL http://abc.com/show.php?dispid=* for each cluster, the preview parameter is erroneously considered to be a content neutral parameter. This can result in a parameter, such as the preview parameter, and/or a value of a parameter, erroneously being considered to be content neutral and not being taken into account in the generalization. A generalization of the cluster normalizations would yield an erroneous generalization of http://abc.com/show.php?dispid=*.

In contrast and in accordance with embodiments of the present disclosure, rules 132 and 134 include the preview component. One or more embodiments of the present disclosure examine the URLs 130 in clusters 1 to 5, and the parameters in the URLs in the clusters, such that it can be discerned that the preview parameter is content determinative, e.g., when the preview parameter has ayes value in URL 130A, the corresponding URL 130B includes a path component named preview. Conversely, if a value of the preview parameter is no, e.g., URL 130G, the path component is not found in the corresponding URL, e.g., URL 130H. The normalization rules generated for each cluster include the preview parameter, and the normalization rules can be analyzed to determine that the preview parameter is determinative of the content, and that the preview parameter can vary. Using this analysis of the normalizations from the clusters, it is possible to generate rules 132 and 134, such that rule 132 applies in a context in which the URL has a preview parameter equal to yes, e.g., the context c(k_{preview})=yes, and rule 134 applies in a context in which the URL has a preview parameter equal to no, e.g., the context c(k_{preview})=no. In addition, rules 132 and 134 include a wildcard substitution for the dispid parameter.

Embodiments of the present disclosure develop URL normalization rules given a set of URLs partitioned into clusters, such that each cluster contains URLs corresponding to a same, or similar content. There are various ways of performing this initial clustering, including creating a small fingerprint of the content of a URL, and then hashing URLs with identical fingerprints into the same cluster. A similarity equivalence can be generated using any technique now known or later developed, which similarity equivalence measure can be used to group URLs in a set, S, into groupings of similar URLs.

Given a set, S, of URLs and a similarity equivalence relation between the URLs, a support and false positive rate for a given rule can be defined. In accordance with one or more embodiments, a support of a rule, r, associated with URLs in a set, S, considered to be similar, denoted supp(r, S), is the number of URL pairs (u, v) in the set of ordered pairs S×S such that v=r(u). In accordance with one or more embodiments, a false-positive count (fpc) of r associated with URLs in a set, S, of URLs considered to be similar, is defined to be the number fpc(r, S) of URL pairs (u, v) in the set of ordered pairs S×S such that v=r(u) but u and v are not equivalent. A false positive rate of a rule with respect to given set of duplicate clusters can represent a measure of the number of non-duplicate pairs of URLs that are rewritten to the same URL by the rule. Rules that have lower false positive rates are more accurate. The false-positive rate of r, denoted fpc(r, S), is defined as fpr(r, S)/supp(r, S). Given a sample of URLs and their similarity information, embodiments of the present disclosure find a set of rules that have high support in the sample, and low overall false-positive rate.

Embodiments of the present disclosure find a set of rules, R, such that for each rule r in the set R, which is a subset of URLs, S, from the set U of URLs have a similarity relationship, the supp(r, S) is equal to or exceeds a minimum support threshold, minS, and the false positive rate, fpr(r, U) is less than or equal to a maximum false positive threshold, maxP. Since each such rule can be seen as “explaining” or “covering” a number of duplicate pairs, the problem of finding a minimum set of such rules becomes a generalization of the NP-hard set-cover problem.

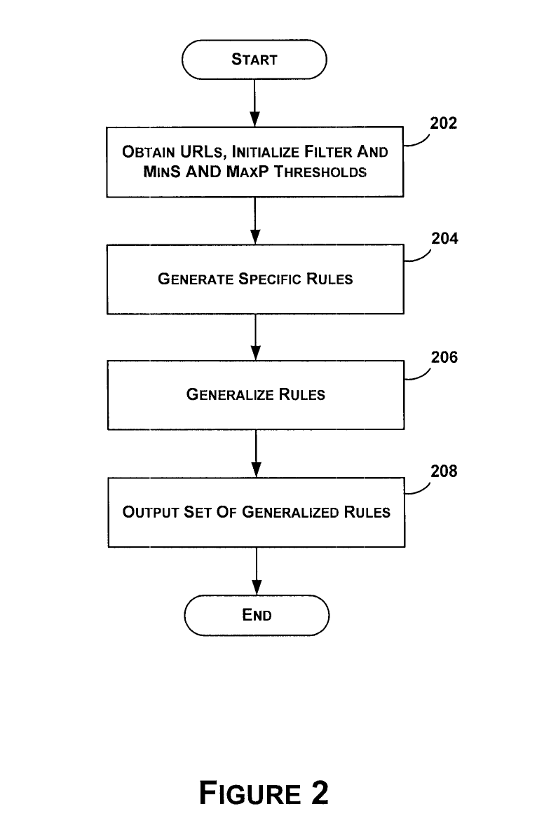

In accordance with one or more embodiments, given a list of URLs and their similarity information, one or more rules are learned by performing pairwise comparisons of keys, or tokens, of similar URLs, e.g., identified based on the similarity information, and creating rules by generalizing one token at a time. FIG. 2 provides an example of a rule generation process flow used in accordance with one or more embodiments of the present disclosure. The process comprises steps to generate a rule to map one or more URLs to a normalized, or canonical, URL. The one or more URLs, which are considered to correspond to the same resource based on their similarity information and are referred to as duplicate URLs, are used to generalize the generated rules.

At step 202, a set of URLs from which rules are to be generated are obtained, together with filter, minS and maxP thresholds. For example, given a set of URLs S, a set of rules R are identified that have support that satisfies a minS threshold and have a false-positive rate that does not exceed a maxP threshold. At step 204, specific rules are generated. In accordance with one or more embodiments, to generate rules, URLs are grouped, or clustered, based on their similarity information, and pairs of URLs u and v within a group are compared to generate a rule corresponding to the two URLs. That is, given a pair of URLs u and v, in a group, a basic rule is created that maps the two URLS, e.g., u to v. The rule that is created comprises a context that comprises a key-value map of one URL, u, and a transformation which identifies the values of v considered to correspond to the values of u. Step 204 generates rules for each pair of URLs in each grouping, or cluster, of URLs.

At step 206, rules generated for each pair of URLs in the clusters are then examined to determine whether two or more generated rules can be generalized using the tokens in the original URLs. Generated rules account for tokens in the URL, even content neutral tokens. In accordance with one or more embodiments, all existing rules r are examined to identify keys k such that rule r can be generalized on key k. A set of candidates for generalization are all the pairs (r, k) such that a delta, or difference, Δ(r, k), is non-zero.

A difference between URLs can be defined to be a difference between mappings K →V for the URLs. Namely, for mappings that are elements K →V for any two URLs u, v, a difference d(u, v) can be defined to be a set of keys k such that u(k)≠v(k). It can be said that the rule r=(c, a) and r′=(c′, a′) differ in key k if either the context at key k is different, e.g., c(k)≠c′(k) or the transformation at key k is different, a(k)≠a′(k). A complementary notation Δ(r, k) can be defined to be the set of all rules r′ that differ from rule r only at key k, or Δ(r, k)={r′|d(r, r′)={k}}.

The generalization is performed by filtering rule-key tuples using a filter that selects candidates (r, k) with a corresponding low false-positive rate when generalized. The selected rules r are examined to identify a generalization on the corresponding keys and stored with appropriate support. A set of generalized rules are output at step 208.

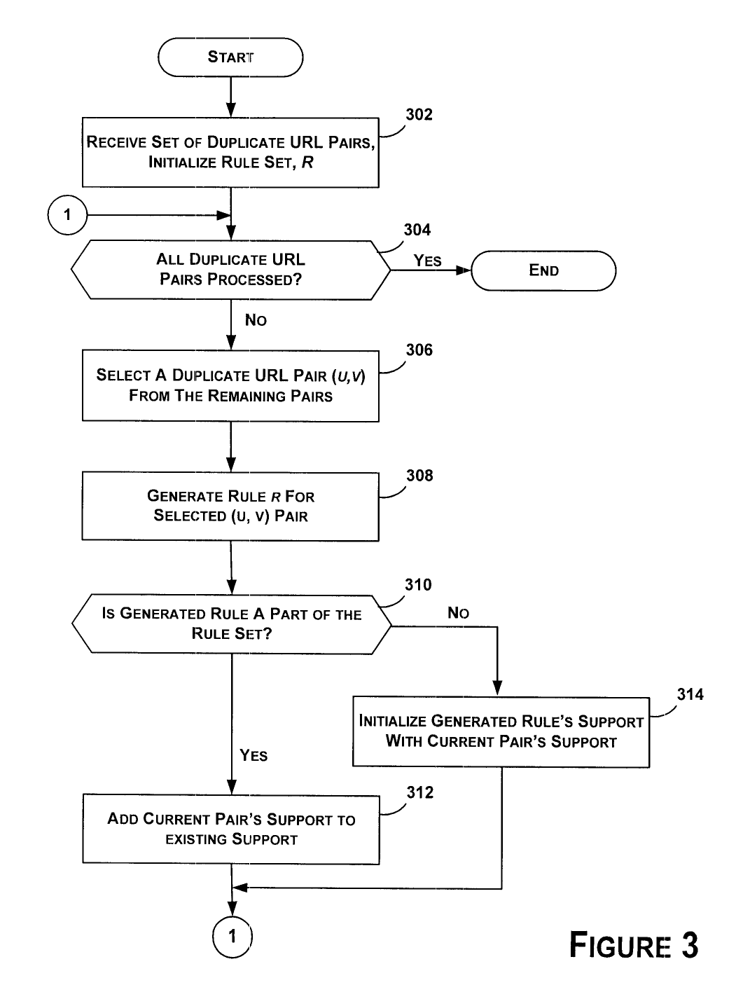

FIG. 3 provides an example of a rule generation process flow for use in accordance with one or more embodiments of the present disclosure. At step 302, a set of duplicate URL pairs are received, and a rule set R is initialized. At step 304, a determination is made whether all of the duplicate URL pairs have been processed. If so, processing continues at step 206 of FIG. 2. If it is determined that there are duplicate URL pairs remaining to be processed, processing continues at step 306 to select another URL pair from a cluster. At step 308, a rule r is generated for the selected URL pair.

At step 310, a determination is made whether or not the rule r generated at step 308 is already a part of the rule set R. If not, processing continues at step 314 to initialize a support value for the newly-generated rule r. The support for the newly-generated rule r, which identifies the number of URL pairs (u, v) such that v=r(u), is initialized to one. If it is determined at step 310 that the generated rule r is an existing rule, the support, e.g., the value of one, is added to the current support value for the generated rule at step 312. Processing continues at step 304 to process any remaining URL pairs in a cluster.

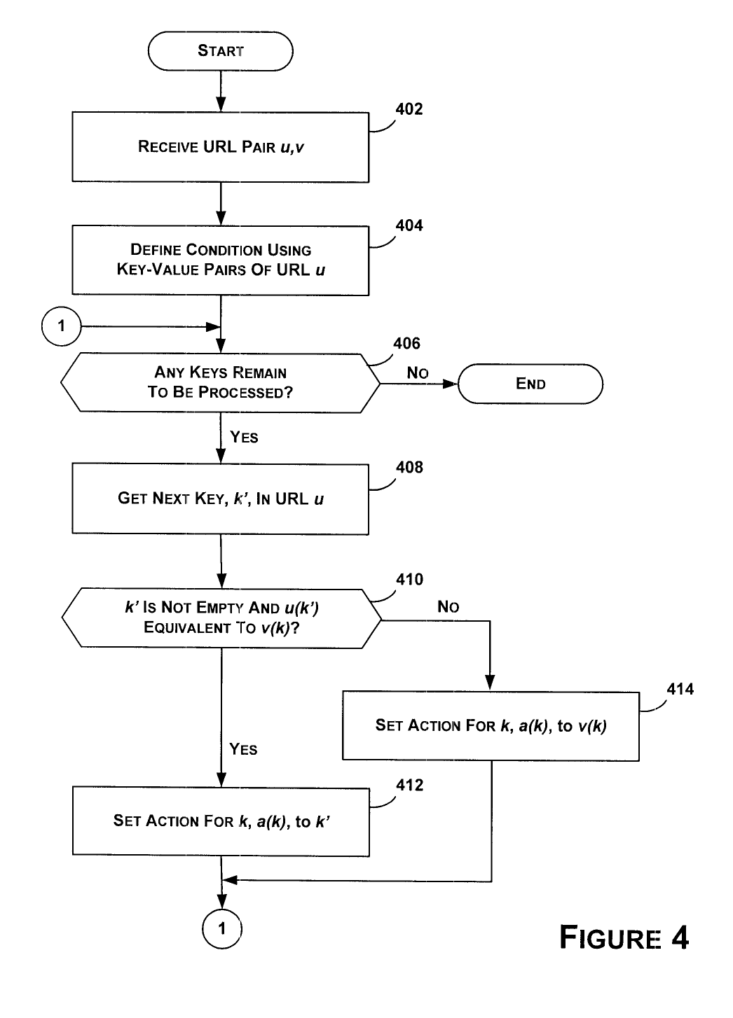

FIG. 4 provides a generate rule process flow for use in accordance with one or more embodiments of the present disclosure. At step 402, a URL pair u, v is received for processing. For example, the URL pair u, v can be received from the process performed in FIG. 3. At step 404, a set of conditions is defined using the keys, or tokens, from the static and dynamic tokens found in one of the URLs, e.g., URL u, in the pair. At step 406, a determination is made whether keys remain to be processed. If not, processing continues at step 310 of FIG. 3. If there are keys that remain to be processed, processing continues at step 408 to get the next key, k′, in URL u. A determination is made at step 410 whether or not the key k′ in URL u is equivalent to a key in URL v. If no equivalence is found, processing continues at step 414 to set the action for the token k in URL v, expressed as a(k), to v(k). If an equivalence is found at step 410, processing continues at step 412 to set the action, a(k), for token k in URL v to the token k′ in URL u. In either case, processing continues at step 406 to process any remaining keys, or tokens.

In accordance with one or more embodiments, the process shown in FIG. 3 is performed for each cluster of URLs, and the process shown in FIG. 4 is performed for each URL pair in each cluster. Referring again to FIG. 2, once specific rules are generated for URL pairs in each of the clusters, process continues at step 206 to process the generated rules so as to generalize the generated rules where appropriate.

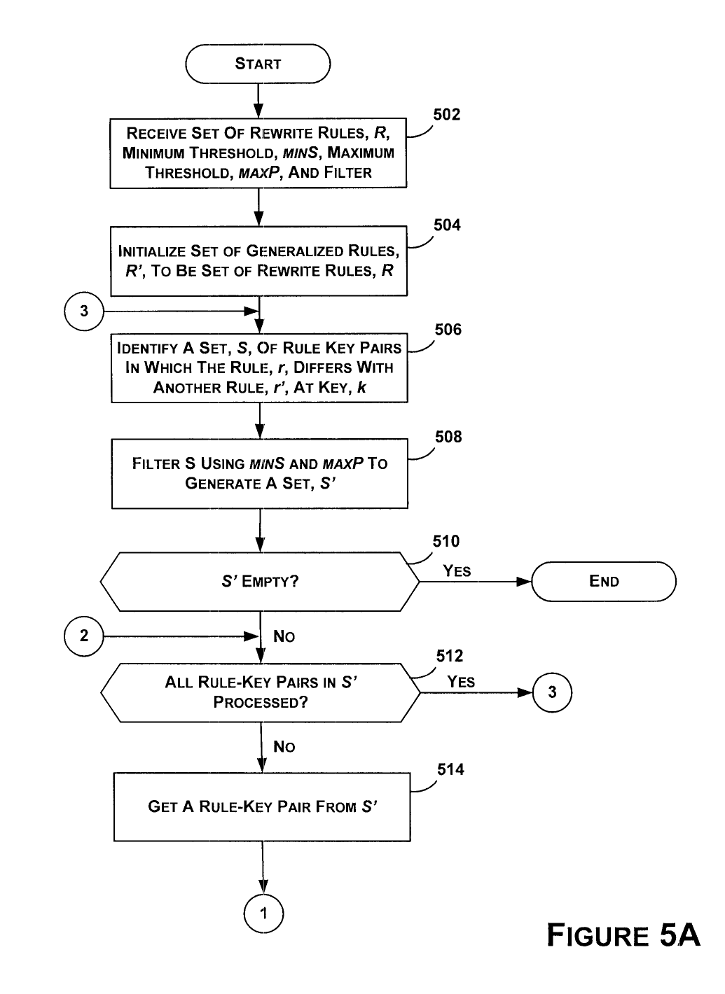

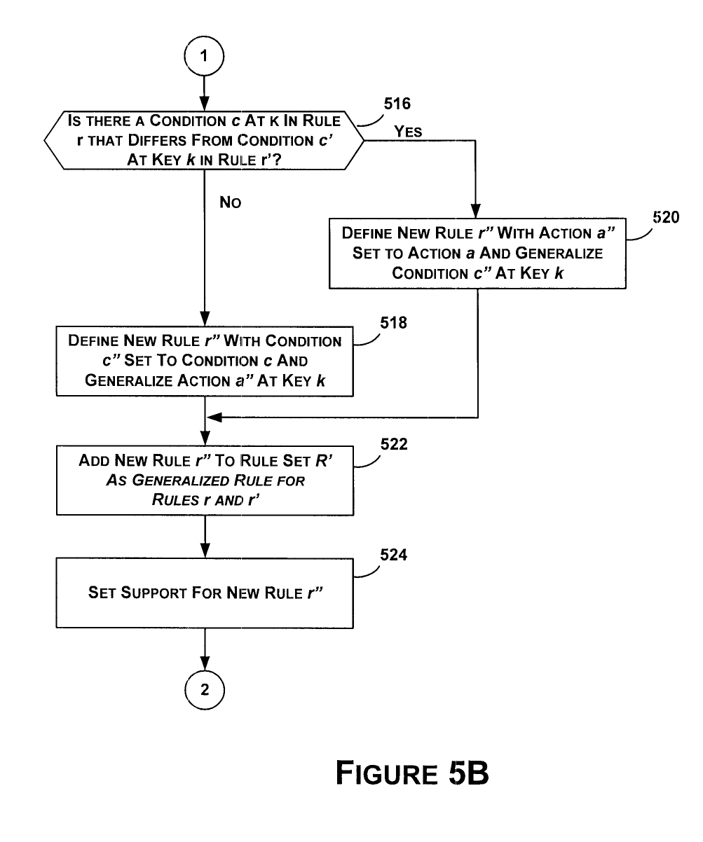

FIG. 5, which comprises FIGS. 5A and 5B, provides a rule generalization process flow for use in accordance with one or more embodiments of the present disclosure. At step 502, a set of rules R is received together with a minimum support threshold, minS, a maximum false positive rate threshold, maxP, and a filter. At step 504, the set of rules R are stored as generalized rules R′. At step 506, a set of rule-key pairs are identified from the rules in which a first one of the rules differs from a second one of the rules in the pair at a key k. At step 508, the rule-key pairs are filtered using the minS and maxP thresholds to yield a set S′ of rule-key pairs that satisfy the minimum support and maximum false positive thresholds.

At step 510, a determination is made whether or not the set S′ is empty. If so, processing ends. Otherwise, processing continues at step 512 to process the rule-key pairs in set S′. At step 512, a determination is made whether or not all of the rule-key pairs have been processed. If so, processing continues at step 506 to regenerate the set S, and the process continues until there are no more rule pairs found that differ for a key k.

If it is determined at step 512 that there are rule-key pairs in S′ to be processing, processing continues at step 514 to get a rule-key pair from S′. Processing continues at step 516 of FIG. 5B. At step 516, a determination is made whether condition c from rule r differs from condition c′ of rule r′. If yes, processing continues at step 520 to define a rule r″ with an action that corresponds to the action a of rule r, and a condition, which is the same as the conditions c and c′ for keys other than the given k and which includes a c″ that generalizes the condition for the given key, e.g., c″(k) →*. If the determination made at step 516 is that the conditions c and c′ do not differ, e.g., are the same, at key k, processing continues at step 518 to define a new rule r″, which has the same condition as conditions c and c′, and with a transformation, or action, that retains the action a and a′ for keys other than the given key k and which includes a generalization for the action a″ at the given key k, e.g., a(k) →*.

The new rule r″ is added to the rule set R′ as a generalized rule for rules r and r′ at step 522. At step 524, a support is initialized for the new rule r″, e.g., the support is set to one.

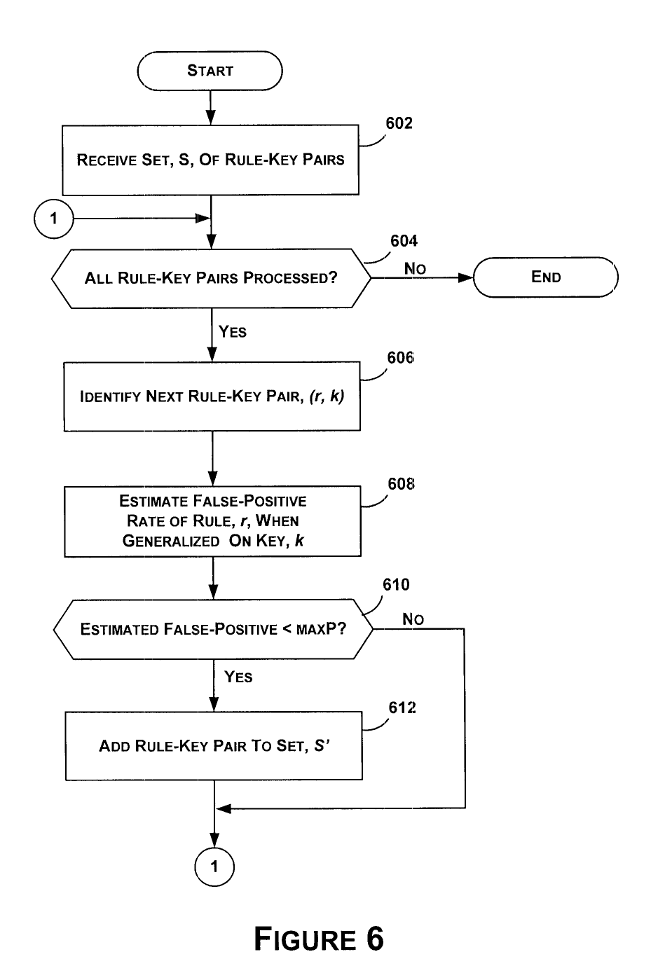

Embodiments of the present disclosure, including embodiments that use process flows described above and in FIGS. 4 to 5, use a filter. FIG. 6 provides a filter process flow for use in accordance with one or more embodiments of the present disclosure.

In accordance with one or more embodiments, a filter can be used in learning URL-rewrite rules that have a large support and a low false positive rate in the sampling of URLs used to learn the rules. One or more such embodiments use heuristics to filter the set of candidates examined for generalization. The following provides examples of such heuristics.

A large fan-out filter can be used to generalize a rule r at key k in a case that the fan-out of the resulting rule is large, e.g., the set of values that k assumes in the rules of Δ(r, k) is large. A high entropy filter can be used to generalize a rule r at key k in a case that the distribution of values that k assumes for rules in Δ(r, k) is nearly uniform, e.g., has a high entropy. Statistically, a distribution of values that is close to uniform can be considered to provide a higher confidence that the key k can be generalized, e.g., generalized to *.

An estimated false-positive filter can be used to generalize a rule r. A false-positive rate for the rule r′ can be defined, which would result from generalizing the rule r at key k. Specifically, if r′=(c′ᵣ, a′ᵣ), let S_{r′} be the set of all URLs u such that u ├ c′ᵣ. A value T_{r′} can be defined as T_{r′}=∪_{ri C- Δ(r, k)}supp(rᵢ). An estimated false-positive ratio, or rate, (fpr) can be determined to be fpr=1−|S_{r′}|/|T_{r′}|. The estimated false-positive rate can be used to decide whether or not to generalize a tuple (r, k) where the estimated fpr<maxP.

At step 602, a set S of rule-key pairs are received, e.g., from step 508 of FIG. 5A. At step 304. a determination is made as to whether or not all of the rule-key pairs have been processed. If so, filtering ends. If not, processing continues at step 606 to identify a rule-key pair in set S that is to be processed/filtered. At step 608, a false-positive rate is estimated for the rule in the rule-key pair selected in step 606 when generalized on key k. At step 610, a determination is made whether or not the estimated false-positive rate is less than the maximum false-positive. If the estimated false-positive is equal to or greater than the maximum false positive, processing continues at step 604 to process any remaining rule-key pairs in set S. If the estimated false positive satisfies the maximum false positive threshold, e.g., is less than, processing continues at step 612 to add the rule-key pair to set S′. Processing continues at step 604 to process any remaining rule-key pairs in set S.

In accordance with embodiments of the present application, URL rewrite, or normalization, rules are automatically generated from a learning set of URLs with content-similarity information. Duplicate URLs can be identified by normalizing URLs using the normalization rules generated, such that two URLs that normalize to the same URL can be considered to be duplicate URLs. By way of a non-limiting example, duplicate URLs encountered for the first time during crawling can be identified without a need to fetch the content, or other resources, associated with the URLs by normalizing the URLs and comparing the normalized URLs. This has a significant advantage of trapping duplicates much earlier in a search engine workflow, thereby improving the efficiency of the overall processing. The system, method and architecture of embodiments of the present disclosure can be used to efficiently learn normalization rules. In one example large scale experiment, over half of the URLs encountered were identified to be duplicate URLs using normalization rules generated in accordance with one or more embodiments disclosed herein.

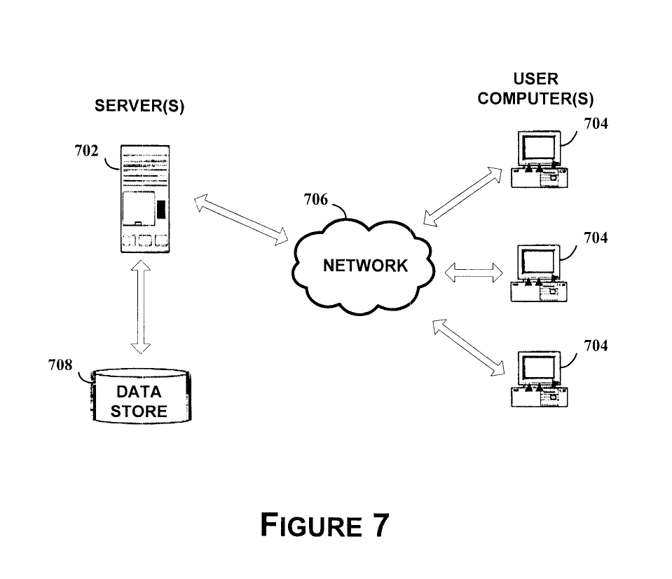

FIG. 7 illustrates some components that can be used in connection with one or more embodiments of the present disclosure. In accordance with one or more embodiments of the present disclosure, one or more computing devices, e.g., one or more servers or other computing device, 702 are configured to comprise functionality described herein. For example, a computing device 702 can be used to identify a set of URLs to be used in a training phase, in which rewrite rules are generated in accordance with one or more embodiments of the present disclosure. The same or another computing device 702 can be used to generate a set of rules in accordance with one or more embodiments. The same or another computing device 702 can use the generated rules to normalize URLs, e.g., to identify duplicate resources without the need to examine the resource content.

Computing device 702 can serve content to user computers 704 using a browser application via a network 706, and can eliminate duplicate content based on URLs normalized using the generated rules. Data store 708 can be used to store URLs, content, normalization rules, thresholds, e.g., minS and maxP, filters, etc.

The user computer 704 can be any computing device, including without limitation a personal computers, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 702 and the user computer 704 can include one or more processors, memory, a removable media reader, network interface, display and interface, and one or more input devices, e.g., keyboard, keypad, mouse, etc. and input device interface, for example. One skilled in the art will recognize that server 702 and user computer 704 may be configured in many different ways and implemented using many different combinations of hardware, software, or firmware.

In accordance with one or more embodiments, a computing device 702 makes a user interface available to a user computer 704 via the network 706. The user interface made available to the user computer 704 can include content items, or identifiers (e.g., URLs) selected for the user interface based on URLs normalized using the rules generated in accordance with one or more embodiments of the present invention. In accordance with one or more embodiments, computing device 702 makes a user interface available to a user computer 704 by communicating a definition of the user interface to the user computer 704 via the network 706. The user interface definition can be specified using any of a number of languages, including without limitation a markup language such as Hypertext Markup Language, scripts, applets and the like. The user interface definition can be processed by an application executing on the user computer 704, such as a browser application, to output the user interface on a display coupled, e.g., a display directly or indirectly connected, to the user computer 704.

In an embodiment the network 706 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 7. Alternatively, embodiments of the present disclosure can be implemented on a standalone computing device, such as the server or computer shown in FIG. 7.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In accordance with one or more embodiments, a user interface with which content items is made available to a user, e.g., the user's computing device, via a network such as the Internet or other network, and content items are made available via the user interface based on win shares associated with one or more of the content items. By way of a non-limiting example, a content item's win share can be used to determine whether or not to make the content item available, the frequency with which the content item is made available, and/or a display order for the content items in the user interface.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
grouping a plurality of uniform resource locators (URLs) that correspond to a resource, each group having URLs whose resource is determined to correspond and each resource determined to be different between groups;
examining each group of URLs to determine at least one normalization rule for the group based on the URLs in the group, each URL in the group comprising at least one component determinative of the resource represented by the URLs in that group;
examining at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

2. The method of claim 1, the generalized normalization rule further comprising a transformation including a string substitution involving the at least one resource determinative component.

3. The method of claim 1, the generalized normalization rule further comprising a context portion and a transformation portion, either one or both of which are generalized.

4. The method of claim 1, said examining at least two normalization rules further comprising:
filtering the at least two normalization rules using support and false positive values for the at least two normalization rules.

5. The method of claim 4, further comprising:
filtering the at least two normalization rules using support and false positive values for the at least two normalization rules, so as to maximum support and minimize false positive.

6. The method of claim 1, further comprising:
applying the generalized normalization rule to a specific URL to generate a normalized URL.

7. The method of claim 1, further comprising:
identifying a set of the normalization rules such that the normalization rules in the set differ at a single key;
filtering the set of normalization rules using support and false positive values associated with each of the rules in the set;
generalizing a pair of rules in the filtered set, comprising:
generalizing condition portions of the pair of rules in a case that the condition portions differ at a single key; and
generalizing transformation portions of the pair of rules in a case that the transformation portions differ at a single key.

8. A computer-readable medium storing computer-executable program code comprising code to:
group a plurality of uniform resource locators (URLs) that correspond to a resource, each group having URLs whose resource is determined to correspond and each resource determined to be different between groups;
examine each group of URLs to determine at least one normalization rule for the group based on the URLs in the group, each URL in the group comprising at least one component determinative of the resource represented by the URLs in that group;
examine at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

9. The medium of claim 8, the generalized normalization rule further comprising a transformation including a string substitution involving the at least one resource determinative component.

10. The medium of claim 8, the generalized normalization rule further comprising a context portion and a transformation portion, either one or both of which are generalized.

11. The medium of claim 8, said code to examine at least two normalization rules further comprising code to:
filter the at least two normalization rules using support and false positive values for the at least two normalization rules.

12. The medium of claim 11, said code to filter further comprising code to:
filter the at least two normalization rules using support and false positive values for the at least two normalization rules, so as to maximum support and minimize false positive.

13. The medium of claim 8, further comprising code to:
apply the generalized normalization rule to a specific URL to generate a normalized URL.

14. The medium of claim 8, further comprising code to:
identify a set of the normalization rules such that the normalization rules in the set differ at a single key;
filter the set of normalization rules using support and false positive values associated with each of the rules in the set;
generalize a pair of rules in the filtered set, comprising:
generalize condition portions of the pair of rules in a case that the condition portions differ at a single key; and
generalize transformation portions of the pair of rules in a case that the transformation portions differ at a single key.

15. An apparatus comprising:
one or more processors configured to:
group a plurality of uniform resource locators (URLs) that correspond to a resource, each group having URLs whose resource is determined to correspond and each resource determined to be different between groups;
examine each group of URLs to determine at least one normalization rule for the group based on the URLs in the group, each URL in the group comprising at least one component determinative of the resource represented by the URLs in that group;
examine at least two normalization rules generated from different groups to determine whether the at least two normalization rules can be generalized into one generalized normalization rule for use with the different groups, the generalized normalization rule to be used to normalize URLs corresponding to both same and different resources and generalizes the at least one resource determinative component.

16. The apparatus of claim 15, the generalized normalization rule further comprising a transformation including a string substitution involving the at least one resource determinative component.

17. The apparatus of claim 15, the generalized normalization rule further comprising a context portion and a transformation portion, either one or both of which are generalized.

18. The apparatus of claim 15, said one or more processors configured to examine at least two normalization rules being further configured to:
filter the at least two normalization rules using support and false positive values for the at least two normalization rules.

19. The apparatus of claim 18, said one or more processors being further configured to:
filter the at least two normalization rules using support and false positive values for the at least two normalization rules, so as to maximum support and minimize false positive.

20. The apparatus of claim 15, said one or more processors being further configured to:
apply the generalized normalization rule to a specific URL to generate a normalized URL.

21. The apparatus of claim 15, said one or more processors being further configured to:
identify a set of the normalization rules such that the normalization rules in the set differ at a single key;
filter the set of normalization rules using support and false positive values associated with each of the rules in the set;
generalize a pair of rules in the filtered set, comprising:
generalize condition portions of the pair of rules in a case that the condition portions differ at a single key; and
generalize transformation portions of the pair of rules in a case that the transformation portions differ at a single key.
